(19) United States
(12) Patent Application Publication
(10) Pub. No.: US 2014/0260816 A1
(43) Pub. Date: Sep. 18, 2014

(54) OPPOSING FORCE TOOL DRIVE SYSTEM

(71) Applicant: William Frank Budleski, Raleigh, NC (US)

(72) Inventor: William Frank Budleski, Raleigh, NC (US)

(21) Appl. No.: 13/804,708

(22) Filed: Mar. 14, 2013

(51) Int. Cl. B25B 13/48; B25B 13/46

(52) U.S. Cl. CPC B25B 13/481; B25B 13/461
USPC 81/57.39

(57) ABSTRACT

The present invention discloses a fastener driver which operates by a push-pull mechanism instead of the standard rotational ratchet.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a system and mechanism for driving a fastener device. In particular, it relates to a drive mechanism using opposing force drives on ratchet type tool heads.

2. Description of Related Art

The ratchet drive is commonly utilized to drive a variety of tool heads particularly for use in driving fasteners of various types. For example, socket heads, screwdriver heads, Allen heads, open and closed wrenches, screws straight, philips, oil driver wrench and the like are all available with a ratcheting mechanism. They provide the ability to use an extension or breaker bar or the like to move the tool head rotationally without having to remove the tool head repeatedly as one would do with a simple box end wrench. They have the ability to have breaker bars torsion measurement or control devices and the like.

In general, ratcheting mechanisms allow installation or removal of bolts, screws and the like by creating a rotation torque clockwise or counter-clockwise. While the body or drive bar or breaker bar needs very little room rotationally to operate a ratcheting head, there are many cases where there is not enough room to make such rotation or apply enough torque on the bar to operate the ratcheting head successfully. A further problem exists where a large torque needs to be applied. In such cases, it is necessary to use two hands to tighten or remove a fastener. Typically, one hand is place on the body (handle, extension, breaker bar, etc.) to provide the force perpendicular to the rotating axis of the bar while the other hand is placed on the ratcheting tool head to contain the opposing force and create the rotational force on the pivoting axis (i.e. the line with the rotational axis of the fastener) at the ratcheting tool head. With a difficult to access fastener position (e.g. an engine compartment) often the source of axis is only perpendicular to the fastener using a socket with a very long breaker bar but is difficult with limited range of movement. If there is a breaker bar, then a third hand is necessary one for the breaker bar, one for the handle, and one for the tool head.

One solution for driving ratchets in tight spaces is the twisting handle drive. For example, in U.S. Pat. No. 8,297,152 there is taught a handle wherein rotation circumferentially clockwise and counterclockwise allows the handle to remain stationary while driving the ratchet head. However, this device achieves this at the expense of torque on the ratchet head. In addition, it is complex to manufacture and can easily break. The cost of ownership is therefore very high with this product even though it does not solve all the problems outlined herein. Old push/pull screwdriver/drill devices are available but, again have limited torque since they have a single axis of force and do not work well if at all with extensions or breaker bars. Accordingly, there is a need in the industry of solving these issues and providing a better means of driving a ratcheting tool head.

### BRIEF SUMMARY OF THE INVENTION

The present invention solves the above problems and more as will be seen from the description herein. By providing a dual-axis push/pull force to drive a tool head the problems can easily be overcome.

Accordingly, in one embodiment there is a system for driving a tool comprising:
a) a tool head;
b) a pair of opposing shafts attached to the tool head and positioned such that when the shafts are engaged in an opposing push and pull manner they drive the tool head.

### BRIEF DESCRIPTION OF THE DRAWINGS

FIGS. 1a, 1b, 1c and 1d are a push/pull set of rods with a ratchet head and the push/pull axis having a socket drive attachment for pushing and pulling.

FIGS. 2a, 2b, 2c and 2d are a rod and tube push/pull arrangement.

FIGS. 3a and 3b are an embodiment of offset extension disconnects and adjustable zero to 90 degree coupling.

FIGS. 4, 4a and 4b are an embodiment of an offset with chain drive.

FIGS. 5a, 5b and 5c are an embodiment of a ratchet head with round gear and linear gears.

FIG. 6 is an embodiment of torque tube drive inner and outer torsion with zero to 90 degree right angle drive.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “about” and “essentially” mean±10 percent.

The term “comprising” is not intended to limit inventions to only claiming the present invention with such comprising language. Any invention using the term comprising could be separated into one or more claims using “consisting” or “consisting of” claim language and is so intended.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, a ratchet is a mechanical device that allows a continuous rotary motion in one direction while preventing motion in the opposite direction. A ratcheting tool head, such as a socket drive, is classically driven by a single handle in a back and forth (usually semi-circularly) that is moved to drive the tool head rotationally and ultimately a tool such as a socket, screw driver head or the like in a particular circumferential manner clockwise or counter-clockwise. In the present invention, the single handle is replaced by a pair of opposing push/pull devices attached to the ratcheting tool head positioned such that when the push/pull devices are engaged in an opposing push and pull manner, they drive the ratcheting tool head.

As used herein “opposing push/pull device” refers to a pair of devices which can be positioned on the tool head. As one device is pushed in one direction, the other is pulled in the opposite direction and then the action is reversed, the device pushed is then pulled and the pulled device pushed. Where they are placed on opposing sides of the rotary portion of the circumferentially moving tool head, they can create a clockwise or counterclockwise motion causing the tool head to ratchet and drive in one direction circumferentially either clockwise or counterclockwise. The push/pull motion of the pair of devices can be driven/done manually (e.g. grab one by each hand and make a push/pull motion) by use of a ratcheting tool which attaches to the push/pull devices, creates a push/pull, a motorized attachment device or the like. In one embodiment, the push/pull devices are separate from the tool head and can be utilized with multiple tool heads. In other embodiments, they are permanently attached to the tool head. In yet another embodiment, there is more than one pair of push/pull devices (for example see FIG. 1c). One skilled in the art can clearly position the push/pull devices without undue experimentation in view of the description and exemplary drawings herein. In some embodiments, the mechanism of push and pull is either linear or torsional.

The push/pull devices could be attached to the circumferential ratcheting tool head by either a releasable means or a fixed means. Releasable means are those deigned to be removed for replacement or repair such as bolts, screws, pins and the like. One type of releasable means are quick-release type mechanisms such as spring-loaded interlocking pieces, clips, quick threaded screws type devices, lever pressure devices, spring-loaded ball-locking devices, pins and the like which are designed to connect and disconnect in a reasonably quick manner. A fixed means is an attachment which cannot or is designed to be difficult to remove the attachment such as by welding, rivets, lock nuts, and the like. In many embodiments, the attachment is a pivoting attachment that allows the push/pull devices to rotate around the attachment point as clearly seen in the figures.

For example, the push/pull devices could be a pair of shafts, a shaft inside a tube, a pair of chains, a pair of arms and the like. They can be driven linearly, torsionally and the like depending on the particular set up and push/pull devices chosen. One skilled in the art can see from this explanation and the exemplary drawings what the push/pull devices can be to drive the ratcheting tool head. In one embodiment, each device is a single piece (e.g. a single rod). In other embodiments, there are multiple pieces forming each push/pull device such as extensions that connect in order to customize the desired length of each of the devices.

Now referring to the drawings, FIG. 1A is an embodiment of the present invention using side by side push/pull shafts. This is an embodiment in a very simple form wherein we start with a circumferential ratcheting tool head 1 which is to be driven circumferentially and wherein socket driver 2 of circumferential ratcheting tool head 1 rotates a socket tool or other tool that can be driven by the circumferential ratcheting tool head 1. In this embodiment, circumferential ratcheting tool head 1 has arm 10 in which two holes 11 are positioned. Each of two push/pull shafts 6 and 7 are pivot bolted 5 to the arm 10 at their distal ends 13 and shown positioned parallel to one another. The shafts 6 and 7 can be any length indicated by 8 and the length can be because of a single length or be connecting multiple shafts together. Connecting lengths of shafts together would be by known means in the art such as quick connect devices screw connectors and the like. While the push/pull devices 6 and 7 could be grasped at their proximal ends 14, in this embodiment a drive unit 3 is shown having hole 4 for inserting a tool head of square design and accomplishing a push/pull motion (as will be seen further from other Figs). The push/pull distal ends 14 are attached to the drive unit via pivoting connections 5a. The drive unit 3 is bolted 5 to shaft 7 through hole 9 making the effective length of the shaft shorter. As illustrated this results in a nonlinear leveraging/speed change in ratio effect as like with Visegrips providing an increased amount of torque. Shaft 6 or 7 could have added holes for flexibility and for tightening as well as loosening fasteners.

FIG. 1B depicts the present invention in a push/pull event that is rotating tool head 1 in a rotational manner 15, either clockwise or counterclockwise depending on how the tool head 1 is set to ratchet. The push/pull event is accomplished by rotating 16 the drive unit 3 which alternatively push/pulls the shafts 6 and 7.

FIG. 10 shows a variation of the device depicted in FIGS. 1A and 1B. It involves the ratcheting tool head 200 with a tool driver 201. In the embodiment, there are a pair of arms 200a and 200b each with hole 200c and 200d rotationally connected 202. In this embodiment, there is a pair of push/pull devices comprising a rod 208 within tube 203 (with a bottom view in FIG. 10). The rod 208 is positioned within tube 203. In this embodiment, the tube 203 is formed from rolled or flat stock but any method is contemplated, to allow coupling at each end by rotational links 202 to the tool head 200 and to the drive unit 206. The rod 208 passes through the inside of tube 203 and is coupled to the ratcheting head 200 by link 204 and to the drive unit 206 by link 205 each forming a rotatable link 202. Once again, the tool can be of any length indicated by 209 and be a single piece or multiple push/pull devices connected together. Rotation is accomplished as in the previous figures by inserting a tool in hole 207 for driving in the same manner.

FIG. 2A depicts another rod within a tube arrangement of the present invention. Wherein the push/pull rod 41 is positioned within push/pull housing tool 40 (sleeve wherein movement opposing one another achieves the desired circumferential movement 61 and 62 of tool head 30 of the type shown in FIG. 1B. The rod 41 is then connected by a pin 63 to a link 60 and then a second pin 62 at the opposite end of the link 60. The sliding inner shell is connected by pin 38 via opposing link 37 and to pin 61 on the opposing side. To minimize the friction optionally, a low friction bushing 39 is utilized by the sliding sleeve and rod bearing could be placed at a desired location where the inner shell is exposed to off-axis sliding load from the links 37 and 60. The links 37 and 60 will reduce off-axis loading and resulting friction loss. If the sliding shell is part of the ratchet housing the pin 38, link 37 and pin 61 could be eliminated though this would create a less balanced load than with the links. The rod 41 is connected by coupling 50 and the outer shell 36, which is connected by coupling 51. For purpose of the device in FIG. 2 is shown offset for illustration but for assembly are in alignment with one another to allow an easy connection fitting the matching pieces. The ratchet head 30 and accessories could have a simple weak spring or other mechanism for maintaining alignment of couplings 50 and 51 and 52 and 53 for a fast connection. (e.g. quick release). The outer locking shell can be slid over the joint and can be retained by any convenient method in the art (e.g. a twist lock).

FIG. 2B is an illustration of an accessory knee joint coupling adjustable from 0 to 90 degrees (illustrated at 90 degrees) which could also be allowed to swivel. The male couplings 52 and 53 would interlock with the coupling 50 and 51 in FIG. 2A regardless of the knee joint is bent to 90 or straight or in-between. Rod 49 is driven in a back and forth manner and coupled to link 47 which drives link 45 which drives link 48 and drives rod 64 as illustrated. The link 45 is stabilized by links 42 wherein FIG. 2c further illustrates the reasonable closeness of the link 45 which maintains a distance relative to the pivot point pin 46. The pivot pin 46 can be one or two separate pins wherein one end is splined to engage within the housing with a retainer and spring to allow pushing on the exposed pin protruding from the housing 34 and 35 to disengage the spline to select a desired angle.

In FIG. 2D the couplings 52 and 53 can be connected to another tool such as an offset ratchet head, knee coupling, offset extension, flex extension and the like. This coupling is driven by rod 54 and coupled to link 65 by pin 55. The link 65 is secured to arm 57 by pin 56. The arm on the front or backside has a square bore of which allows a connection of a drive. This can be driven by e.g. a breaker bar, handle, extension or a permanently attached handle. A low friction bushing could also be utilized to minimize friction points.

FIG. 3A is another example of a rod within a tube arrangement ratchet head of which can be combined with the FIG. 2A ratchet head. The housing 78 has rod 77 of which it's back and forth action drives the two curve gears 70/71 with teeth on the inner radius. The gears pivot on pin 74 independently of which are connected to the actuator 76. These gears have light loading against pinion 72 by spring 79. Not shown is a lever which will keep either one of these curved gears with the drive pinion gear 73 and is shown with gear 70 making contact. Upon pulling the plunger 76 away from pinion 73 it will force rotation of the pinion 73. Upon moving the plunger 76 toward the pinion 73 the gear 70 up and over each tooth creates a pawl ratcheting effect. The angle of the teeth surface must be greater than 90 degrees relative to the pin pivot point 74 to maintain engagement in one direction with lifting over the teeth and not engaging in the other direction. This eliminates the need for a separate pawl ratcheting mechanism as in FIG. 2A. If FIG. 2A is combined with the drive mechanism of 3A it creates a two speed ratchet mechanism. The plunger is separate from rod 77 with its connective loading being controlled by the strength of spring 75. After a fastener (example nut or bolt) is loosened this light loading allows the fastener to be turned dramatically faster of up to many times overdrive of normal speed. The standard ratchet pawl action of FIG. 2A is over driven, allowing the overdrive and the ratio of the overdrive to be approximately based on the difference between the pitch diameter of pinion 73 in FIG. 3A and the spacing of the pins 61 and 62 in FIG. 2A. Upon heavier loading a threshold is achieved with the spring being over powered and now the pawl effect between To reverse fastener rotation the traditional lever is moved in reverse position as used in the typical pawl of FIG. 2A of which also in FIG. 3A lifts gear 70 with gear 71 freed to move inward for engagement. This is just one example of creating a ratcheting mechanism with or without overdrive.

FIG. 3B is a simple form of the FIG. 2B knee joint of a fixed ninety degree angle eliminating numerous noncritical parts. The couplings were not shown since it was the same as above. Forces on rod 82 push/pulls on link 84 of which push/pulls on lever 85 of which push/pulls on link 86 and push/pulls on rod 87 with the pivot points at pins 88. Rods 80 and 87 could/are stabilized by bushing 83. A swivel could be created by separating the housing from pins 88 with retaining collar 89. With tube 89 pulling on pin 90 this allows allow rotation of any angle. This swivel action is also on rod 87.

FIG. 4A This is an offset tool of limited torque contained within the cut away view of the housing 109 of which can be manufactured of any length not revealed in center region 111. The housing 109 contains off the shelf single or double row #35 or other type chain 110 and sprockets 113 and 114 with a male end of appropriate size drive 115 on the sprocket 113 with a female drive 116 on the sprocket 114 to reduce the width of the housing for low friction inserts 112 can be put in place as shown. Since this is of continuous rotation, a typical ratchet can drive the mechanism. If sprockets 113 and 114 are of different size with a female attachment on the backside of the sprocket and a male on the backside of the sprocket 114, then it allows the device to be reversible having higher torque with the larger sprocket on the drive fastener or less toque with the smaller sprocket on the drive fastener. To reduce the wear on the inserts 112 the link 125 could have the radius 124 FIG. 4B correspond to the radius insert 112.

FIG. 4 is an offset tool requiring the drive end 122 to have a standard pawl ratcheting arrangement like shown in FIG. 2A. It also requires a weak recoil spring as in lawn mower recoils. Likewise, it also requires the same layout on opposing 120 end. Each end must have a male drive on one side with a female drive on the backside since this is not reversible. The positive is like a lawnmower recoil pull starter, the ratio will vary depending on how much chain is wound on either end. Since it is a lift chain not needing rollers for tooth sprockets it would have twice the links with close to twice the strength for a given chain.

FIG. 5A Is an exploded ratchet 130 driven by an offset flex joint 139 extension and will drive and be driven by an appropriate drive (metric or English drive) or has a handle directly attached. The unique quality of this tool is that it can transform from a totally flexible extension into a totally rigid tool by flipping a lever.

This flex joint can be comprised of just a single unit with a FIG. 5A ratchet head, flex joint and FIG. 5B driver end as shown or with a handle on driver end. This can just be of an extension as represented in FIG. 2B with a coupling in each end to couple to FIG. 2A and FIG. 2D for connection with all of the fore mentioned tools. The flexible extension can be of any length and diameter as desired allowing up to massive load carrying capabilities as in having a supporting base or mount on one end and a chair, table, lamp and etc. . . . attached to it on the other end. As another example it can have coupled on one end as example a flat surface, hammer head, pneumatic or electric of say several inches in diameter to be placed within a non accessible fender to remove a dent with the flex joint routed outside. Upon transforming the flex shaft into a solid shaft. This allows providing leverage from outside the panel. This flex joint can also be on a small scale for use in certain surgical applications. With the flex shaft and a video camera on the end, it can be routed into a region with a portion of it being controlled like a snake with an added device on the end to fulfill a given task remotely. This flex shaft has numerous applications from coupling as an offset tool extension to a ratchet head, torsional extension, universal with an extension breaker bar and the like, but also have numerous added uses as covered as some examples.

This is another ratcheting driven version similar to the 2A of the push/pull configuration with the cable 134 connected by pin 132 providing tension to circumferentially turn the ratchet head counterclockwise and the cable 136 connected by pin 131 provides tension to provide clockwise rotation. The opposite end of the cable 134, cable 144 is coupled to the circumferentially driver end 141 by pin 142. The opposite end of the cable 136, cable 146 is coupled to the circumferentially driver end 141 by pin 147. The structure 130 and 141 and vertebra 139 links provides compression. The tool besides containing the pull cables for creating the rotation forces to drive sockets and etc. . . . also has the tensioner cable 137/145 for creating the transformation from the flexible configuration to rigid. The cable 137 is connected to the ratchet head 130 structure by pin 133. The opposite end of cable 137 coupled to 149 is the threaded rod 150. The cam action of the lever 151 will draw upon the threaded rod 150 results in the taught cable 145/137 creating significant compression of the vertebra links 139 transforming the flexible vertebra into the rigid configuration. The connecting pieces are like vertebra within in a human back allowing flexibility with its configuration held in place by instead of a cable but by muscles/tendons.

The vertebra 156 revealed in the vertebra 157 sideview has the concave 162 spherical surface with the opposite end of convex spherical surface 163 with the hole 161 through it. The low friction insert 165 has three tapered holes 164. The radiused flange 166 allows the insert to slide within the vertebra 157 a set amount and prevents the insert from getting hung up on the adjacent vertebra. The angle of the contact with the multiple vertebra surfaces in contact with one another is on the threshold of almost wedging together. Thus upon on drawing the center cable of which runs through them will minimize the needed tension to create a rigid configuration.

The cylindrical version vertebra components 152/153/154/155 as example is comprised of threaded rod cut in lengths 154 with three holes 160 placed through it to provide passage of the three cables. As revealed in the cutaway view 155 the holes are tapered form to allow freedom of movement and to keep the cables close to the center of the center of the cylindrical surface. The mating cylindrical vertebra 152 is created from square bar stock by bored and tapped through and cut at given intervals creating the cylindrical vertebra 152. In the boring process the side view 153 reveals the added notched smooth area 159 to minimize the radius of contact between the mating pieces in the threaded region. The angle of the radius between the two mating parts is on the threshold of almost staying wedged together minimizing the required tension of the tensioner cable 137/145. The threaded cylindrical surface instead of a smooth surface reduces the required angle for the wedging effect.

Not illustrated are countless other versions of the “vertebra” 152, 154 and 156 can be created and can be of interlocking nature to minimize the risk of the vertebra dislocating. As covered this tool has many applications besides just driving sockets.

FIG. 6 shows a tool of continuous rotation like the FIG. 4A offset chain tool but utilizes a right angle (90 degree) bevel drive on each end. It is significant variation but once again the same as in having simultaneous counter acting push/pull forces with the tool stabilized as a single unit. This is comprised instead of parallel push/pull rods or a rod within a tube this is of a rod 177/197 within a tube 180/185 with the rod 177/197 being torsional in one rotation with the tube 180/185 being torsional in the opposing rotation. The outer tube 180 is coupled to the spider gear 178 and the inner rod 177 is coupled to the opposing spider gear 169, with these gears rotating in opposite directions driving each side of the bevel gear 173 of which rotates an extension or socket inserted onto the coupling 172. The driven end of the tool is the same with the tube 185 coupled to the spider gear 187 and the inner rod 197 is coupled to the opposing spider gear 196, with these gears rotating in opposite directions driving each side of the bevel gear 198 of which is driven by a drive inserted into female drive 189. The bevel gear 173 has a thrust bearing 175 or washer, the rod 177 has the bearing 168 to support it. The outer tube 180 is supported by the bearing 176 within the housing 170. The bevel gear 198 has a thrust bearing 188 or washer, the rod 197 has the bearing 190 to support it. The outer tube 185 is supported by the bearing 186 within the housing 171. The spider gear 196 has splines on it's inside diameter allowing it to slide on the splines 194 on the rod 197. The spring 191 forces the spider gear 196 against the twist lock 193 with friction minimized by the thrust bearing 195. By rotating the twist lock 193 it will move inward one way allowing the spider gear 196 to be engaged with the bevel gear 198. By rotating the twist lock 193 the opposite way this allows the spider gear 196 to move to the right disengaging from the bevel gear 198 with this feature allowing the housing 171 and 176 to be rotated at any selectable angle relative to the housing 170. Reengaging the spider gear 196 by the twist lock 193 will secure the angle. This torsional and counter rotational design can be of a quick connect/disconnect couplings. The rod 177 has male splines 181 to engage with the rod 197 female splines 183. The tube 180 has male splines 182 to engage with the tube 185 and splines 184. This assembly is kept together by a sliding twist locking coupling 179. These two units allow connecting extensions and other items as example covered in the push/pull version. Once again this is just like with the push/pull arrangement offset tool with this rotational and counter rotational forces are neutralized within single unit eliminating the need to place any hand within a difficult access compartment. This tool has the same result as FIG. 4A chain of being continuous rotation with no ratcheting mechanism and by two spider gears engaged on bevel gear doubling it's torque for a given gear size. If the spider gears are half the size as the bevel gear this will reduce the load on of the rod and outer tube by half.

A simple significant variation is utilizing only the housing 170 side with only a single one to one drive ratio utilizing the outer tube 180 of which is now a solid rod and spider gear 178 but eliminate the inner drive rod 177 and spider gear 176 and related parts thus creating a simple right angle 90 degree universal of which takes the standard male ¼, ⅜, ½, ¾ and etc. . . . drives on one end and the corresponding female on the other end in place of the splines 181/182. The device is a constant velocity universal joint. A variation of this as like FIG. 2B creates a set angle universal. Existing universals in tool boxes has difficulty by of not being constant velocity and not being of fixed angle which causes the extension and socket or socket to receive inconstant torque and to squirm off the fastener. This can be corrected by combining two universals together as like on vehicles to create constant velocity or as with gears or other constant velocity arrangement in a fixed housing of a fixed or selectable discrete angles which can be set eliminating the problem.

FIG. 2A, 2B, 2C, 2D, FIGS. 3A and 3B can also be of hydraulic variation in the same push pull tool design. The hydraulic version is similar to the FIG. 2A except instead of a center rod there is hydraulic fluid providing the pushing force and the outer casing provides the tension. The ram 41 is located anywhere in this region of which is coupled to pin 63. FIG. 2D on the opposite end ram 54 is located anywhere in this region which is coupled to pin 55. An example of ram is http://www.mackcorp.com/Catalog/Hi_nrgy_pg37/hienenergy37.html with addition of connectivity to pin 63/55. This hydraulic approach greatly simplifies the non adjust knee FIG. 3B since the fluid would just flow around the corner as in any hydraulic elbow coupling. For the adjusting angle knee joint FIG. 2B no linkage is needed and the pin 46 is of a typical hydraulic swivel joint allowing pressurized fluid flow around any selectable angle or a short hydraulic hose could be used. By not having quick disconnects this would minimize air intrusion. For a single acting hydraulic device the FIG. 2A head 30 would not be reversible therefore having male drive couplings on the front side as well backside would allow reversing rotation. The driven end 31 may or may not have two female driven couplings 59. The head 30 would have return spring to ratchet back the rams after each leveraging force on the driven end. With a double acting ram with a second flow path a return spring is not mandatory. FIG. 3A can also be a hydraulic version with the cylinder 77 housing the ram 75 of which this geared version is reversible. In reference to the flex joint FIGS. 5A and 5B instead of cables hydraulic lines could be used. A typical hydraulic quick disconnect can be used though do to air intrusion two added rams at 50 and 53 would provide isolation of fluid from air.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for driving a circumferential ratcheting tool head comprising:
a pair of opposing push/pull devices attached to the ratcheting tool head positioned such that when the push/pull devices are engaged in an opposing push and pull manner of operation they operate the ratcheting tool head circumferentially.

2. A system according to claim 1 wherein the push/pull devices are driven by a ratcheting tool driver.

3. A system according to claim 2 wherein the ratcheting tool driver is a ratchet wrench head.

4. The system according to claim 1 wherein the opposing push/pull devices are a pair of parallel shafts.

5. The system according to claim 1 wherein the opposing shafts are a shaft within a tube.

6. The system according to claim 1 wherein the push/pull devices are attached to the circumferential ratcheting tool head.

7. The system according to claim 1 wherein the push/pull manner of operation is linear.

8. The system according to claim 1 wherein the push/pull manner of operation is torsional.

9. The system according to claim 1 wherein the push/pull devices are attached to the ratchet tool driver by a quick release mechanism.

10. A system according to claim 1 wherein the push/pull manner is hydraulic pressure and tension of the housing.

11. The system according to claim 1 wherein the push/pull devices are attached to the ratchet tool driver by a fixed mechanism.

12. The system according to claim 1 wherein the push/pull manner is nonlinear.

13. The system according to claim 1 wherein the push/pull is direct drive or overdrive

14. The system according to claim 13 wherein the direct or overdrive is manual or automatic.

15. A universal joint for tools of constant velocity of a fixed of selectable discrete angles.

16. A flexible cabled coupling system of which can be set from flexible to rigid and back again.

17. The system according to claim 15 wherein the universal can be of a non opposing singular torsional force.

18. The system according to claim 4 wherein the parallel shafts are quick disconnect or telescopic.

19. The system according to claim 5 wherein the shaft within a tube is quick disconnect or telescopic.
